(19) United States
(12) Patent Application Publication
(10) Pub. No.: US 2009/0026193 A1
(43) Pub. Date: Jan. 29, 2009

(54) Flexible Flooring Heating Systems

(76) Inventor: Richard Montague Adams, Fielding (NZ)

Correspondence Address: SEED INTELLECTUAL PROPERTY LAW GROUP PLLC, 701 FIFTH AVE, SUITE 5400, SEATTLE, WA, 98104, US

(21) Appl. No.: 11/578,887

(22) PCT Filed: Apr. 28, 2005
(86) PCT No.: PCT/NZ05/00086

§ 371 Date: Sep. 27, 2007

(30) Foreign Application Priority Data
Apr. 30, 2004 (NZ) NZ532691

(51) Int. Cl. H05B 3/34; B23P 11/00

(52) U.S. Cl. 219/528; 29/428

(57) ABSTRACT

The present invention relates generally to an improved method of assembling a floor cover heating system where the floor cover is flexible in nature, such as a carpet or rug, in particular the invention provides an improved method of reducing the wear of under floor heating mats from abrasion. The invention also provides a floor cover heating system including a flexible floor cover layer, and under floor cover heating mat, and a slip layer positioned between the heating mat and the flexible floor cover.

The present invention relates generally to an improved method of assembling a floor cover heating system where the floor cover is flexible in nature, such as a carpet or rug, in particular the invention provides an improved method of reducing the wear of under floor heating mats from abrasion. The invention also provides a floor cover heating system including a flexible floor cover layer, an under floor cover heating mat, and a slip layer positioned between the heating mat and the flexible floor cover.

### BACKGROUND

Under carpet heating systems have been used for sometime in New Zealand and Australia, South Africa and other countries. Under carpet heating systems consist of an under carpet heating mat which is encapsulated in a reinforced high temperature foil, or the like for added protection and heat transfer. The heating mat sits between the carpet layer and the carpet underlay layer. These heating mats can quickly heat up a room and can be automatically thermostatically controlled to suit temperature changes and life style options.

One of the difficulties with this system is that the under carpet heating mats have occasionally worn on the top side of the mat, that is the side of the mat that butts up against the underside of the carpet layer. It has generally been recognised that this has been caused by the abrasiveness of the under side of the carpet rubbing against the under carpet heating mat. The problem has been more pronounced in areas where the carpet is exposed to frequent use such as hall ways, corridors or commercial applications such as show rooms where heavy foot traffic is experienced.

It is an object of the present invention to over-come these difficulties and to provide the consumer with a longer wear under carpet heating system, or to at least provide the public with a useful choice.

### SUMMARY OF THE INVENTION

In a first aspect the present invention provides a method of installing a floor cover heating system over a floor surface, including the steps of
locating a heating mat over the floor surface and under the flexible floor cover layer, and
locating a slip layer between the heating mat and the flexible floor cover.

Preferably the method includes the step of locating under the heating mat an underlay layer.

Preferably, the flexible floor cover layer is a carpet layer or a rug layer that does not include an insulative backing layer.

Preferably, the slip layer will be of a size substantially equivalent to the dimensions of the under carpet heating mat.

Preferably, the slip layer is a synthetic material.

Preferably, the slip layer is a synthetic material, such as polypropylene or nylon. More preferably, the slip material is polypropylene 100 gsm spun bound.

Preferably the thickness of the slip layer is between 0.1-2.0 mm. More preferably, the thickness of the slip layer is between 0.4-0.8 mm.

In a second aspect the present invention provides an under floor heating system including:
a flexible floor cover layer
an under floor cover heating mat, and
a slip layer between the heating mat and the flexible floor cover.

Preferably, the flexible floor cover layer is a carpet layer or a rug layer that does not include an insulative backing layer.

Preferably, an underlay layer is located underneath the heating mat.

Preferably, the slip layer will be of a size substantially equivalent to the dimensions of the under carpet heating mat.

Preferably, the slip layer is a synthetic material, such as polypropylene or nylon.

Preferably, the slip layer is poly propylene 100 gsm spun bound.

Preferably the thickness of the slip layer is between 0.1-2.0 mm. More preferably, the thickness of the slip layer is between 0.4-0.8 mm.

In a third aspect there is provided a method of reducing abrasion between a flexible floor cover layer and a heating mat positioned over a floor surface including the steps of
locating a heating mat over the floor surface and under the flexible floor cover layer, and
locating a slip layer between the heating mat and the flexible floor cover.

Preferably the method includes the step of locating under the heating mat an underlay layer.

Preferably, the flexible floor cover layer is a carpet layer or a rug layer that does not include an insulative backing layer.

Preferably, the slip layer will be of a size substantially equivalent to the dimensions of the under carpet heating mat.

Preferably, the slip layer is a synthetic material.

Preferably, the slip layer is a synthetic material, such as polypropylene or nylon. More preferably, the slip material is polypropylene 100 gsm spun bound.

Preferably the thickness of the slip layer is between 0.1-2.0 mm. More preferably, the thickness of the slip layer is between 0.4-0.8 mm.

The term slip layer includes any layer, synthetic or non-synthetic, that has the ability to reduce abrasion between the floor covering layer and the heating mat and/or to assist in the dispersion of heat from the heating mat.

Further aspects of the present invention will become apparent with reference to the following description and figures in which;

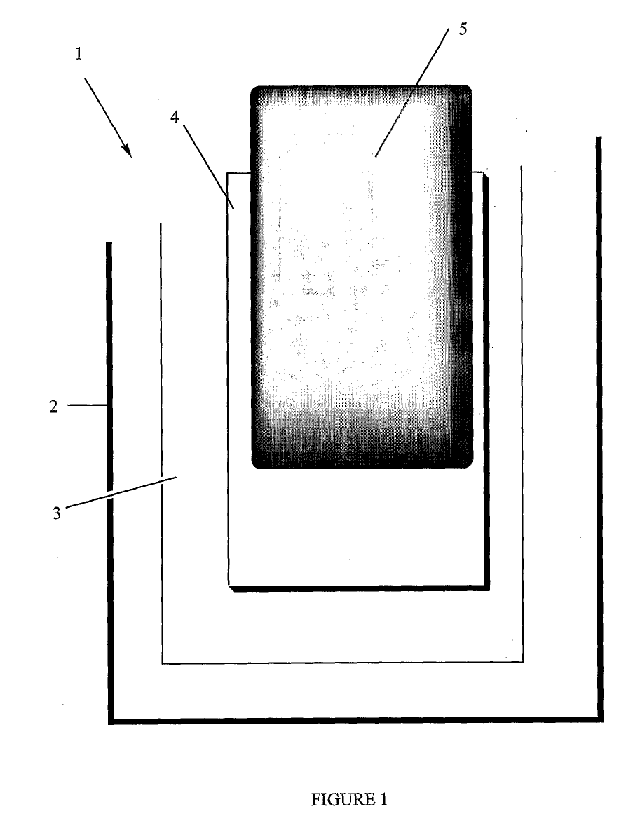

FIG. 1 illustrates schematically a plan view of a conventional under carpet heating system; and

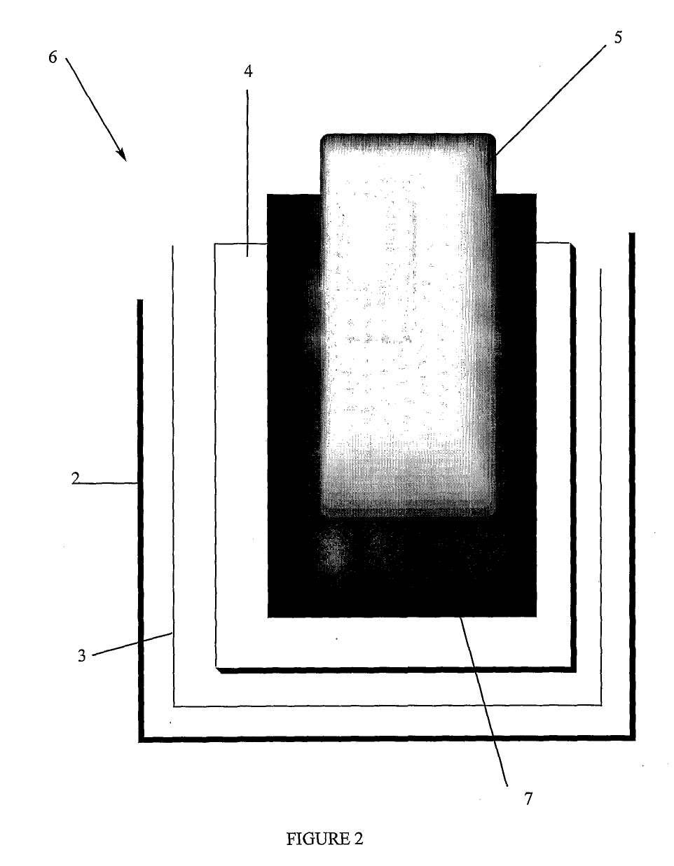

FIG. 2 illustrates schematically a plan view of an under carpet heating system including a slip member.

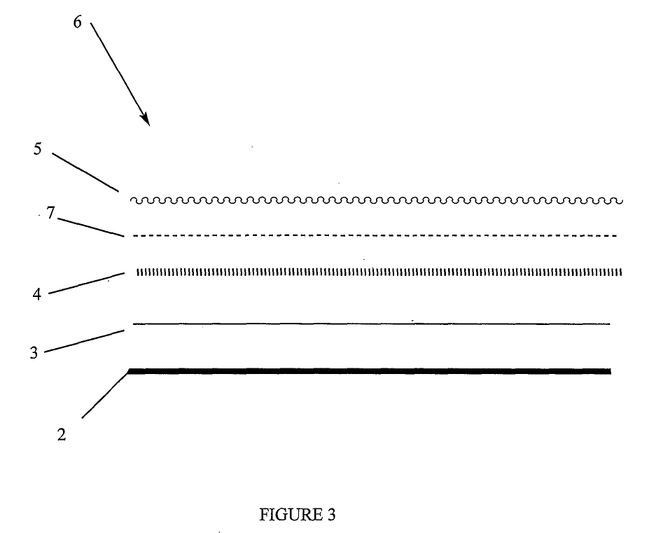

FIG. 3 illustrates an exploded side view of the under carpet heating system shown in FIG. 2.

### DETAILED DESCRIPTION

A conventional under carpet heating system 1 is shown in FIG. 1. The ground surface 2 is covered by an underlay layer 3. The heating mat 4 is located on top of the underlay layer 3. The heating mat is a low temperature electric radiant heating mat. On top of the heating mat 4 is positioned a carpet layer 5. With this conventional system, some damage has been caused to the heating mat through repeated abrasion experienced between the underside of the carpet layer and the heating mat. The heating mats are encapsulated in a reinforced high temperature foil. The abrasion between the underside of the carpet layer and the heating mat has caused the foil on the heating mat to be damaged and worn away in some instances, such as areas where the carpet is exposed to high levels of foot traffic. Efforts have been made to try to secure the carpet layer tightly to prevent any movement of the carpet relative to the heating mat.

A heating system 6 of the present invention is illustrated in FIGS. 2 and 3. The invention surrounds the surprising finding that the introduction of a slip layer 7, under the carpet layer 5 as illustrated in FIG. 2 or 3, significantly reduces the wear and tear on the heating mat 4. The slip layer 7 is preferably a thin layer of approximately 0.1-2 mm of polypropylene, such as polypropylene 100 gsm spun bound or a similar type of synthetic material such as nylon or the like. Preferably, the slip layer is dimensioned to overhang the heating mat to enable the slip layer to be secured to the underlay layer 3. The inventor has found that the best results appear to be achieved when the heating mat is not secured directly to the heating mat 4.

The inventor has surprisingly found that despite being such a thin layer of slip material, the layer has the ability to dampen the abrasion effect experienced in the conventional system. The inventor has also found that the slip layer does not in fact interfere with the heating ability of the heating mat, nor does it restrict or limit the heat transfer or cause a localised build up of heat in places where the heating mat and carpet are brought under pressure.

When assembling the heating system, the ground surface 2 is prepared and should be clean, dry and level. The ground surface or substrate may be wooden, wood fibre composite or concrete.

When carpet is being laid as the floor covering, a carpet underlay layer 3 is next secured to the ground layer by tape or glue or some other non-conductive fastening means.

The area to be heated is calculated and then the heating mat is cut to size and positioned over the underlay in such a manner so that the selected area to be heated is covered.

The slip layer is then positioned over the heating mat and is secured with the likes of glue or tape preferably to the edges of the underlay. The carpet layer can then be rolled out over the slip layer. Preferably the carpet layer is a Hessian backed carpet layer or similar. Rubber backed or foam backed flexible floor covering by virtue of their insulative properties are not suitable to use with the heating mats.

The invention will be further described with reference to the following examples.

### EXAMPLE 1

### Abrasion

On a 19 mm MDF floor a ripple underlay was laid, a 250W undercarpet heating mat was positioned over the underlay. A very coarse 3M® polishing pad, normally used to buff stainless steel and a 6 kg weight were then used in the following tests.

Test 1: The polishing pad was placed on top of the heating mat in position over two wires (covered by foil) from the heating mat. The two wires extended across the width of the heating mat. On top of the polishing pad was placed the 6 kg weight. This 6 kg weight was then dragged along the length of the wires 20 times. At the end, there were visible signs that the foil on the heating mat was starting to wear off. The worn heating mat was replaced and then the polishing pad and 6 kg weight was then dragged across the width of the wires 20 times and again there were visible signs that the foil on the heating mat was starting to wear off.

Test 2: Using the same pad and weight described in Test 1 a piece of polypropylene 100 gsm cloth was placed on top of the foil of the heating mat. The polishing pad and then the 6 kg weight were positioned on top of the heating mat. After 60 times of being repeatedly pulled across the width of the heating mat and 50 times across the length of the heating mat there was no visible sign of wear.

### EXAMPLE 2

### Heating

A Zone 1 area was set up on a 19 mm MDF floor. A ripple underlay was laid, a 250W undercarpet heating mat that loomed at 170 Watts per square meter was positioned over the underlay. A slip layer of polypropylene 100 gsm cloth was then positioned over the heating mat and then a wool carpet layer was secured over the slip layer and heating mat. The following heating trials were conducted with an initial air temperature of 17 degrees C.

A Zone 2 area was set up on a 19 mm MDF floor. A ripple underlay was laid, a 250W undercarpet heating mat that loomed at 170 Watts per square meter was positioned over the underlay and then a wool carpet layer was secured over the underlay and heating mat. The following heating trials were conducted with an initial air temperature of 17 degrees C.

In an area of carpet under Zone 1, a plastic lid with a hole drilled through the lid was placed on the carpet surface (Test 1). Through the hole was passed a temperature probe wire and then a 3 inch diameter washer was placed on top to hold the wire and lid in position on the carpet surface. The temperature was monitored over time.

In another test on a Zone 1 area a 25 mm square of copper was used with the temperature probe wire and fastened with a paper clip (Test 2). The plate was placed on the carpet with an eraser as the weight but not totally covering the copper plate. The temperature was monitored with time.

The results are shown in the following tables:

| | |
|---|---|
| Zone (Test 1) | Temperature in Degrees C. |

| | | | | |
|---|---|---|---|---|
| 1 | 18 | 27 | 31 | 35* |
| 2 | 18 | 26 | 30 | 33* |
| Time (mins) | 0 | 30 | 60 | 90 |

*The above test shows quite high temps at 90 mins but this was because the probe wire was not exposed to the air.

| | |
|---|---|
| Zone (Test 2) | Temperature in Degrees C. |

| | | |
|---|---|---|
| 1 | 27 | 27 |
| 2 | 28 | 27 |
| Time (mins) | 30 | 60 |

A further test (Test 3) was conducted continuing on with the Test 2 conditions and involved applying a slight weight (approx. 5 gms) pressure to the copper plate. The temperature over time remained at 27 degrees C. for both of the Zones.

Another test (Test 4) was conducted continuing on with the Test 2 conditions but this time involving the placement of the 1.5 kg weight over the copper plate continuously and monitoring the temperature under both Zone 1 and Zone 2 conditions.

The results are shown in the Table below

| | |
|---|---|
| Zone (Test 4) | Temperature in Degrees C. |

| | | |
|---|---|---|
| 1 | 27 | 30 |
| 2 | 27 | 31 |
| Time (mins) | 0 | Up to 180 mins |
| | | (stable temperature) |

Other tests were also conducted whereby the probe was positioned in different places between the heating map and the slip cloth, and then orientated in different positions relative to the heating wires in the heating mat. In all such tests there was virtually no difference experienced between the different Zones, strongly suggesting that the slip layer did not interfere or compromise the movement of heat away from the heating mat.

From these examples and tests it can be concluded that the use of a slip layer did not affect the heat transfer from the heating mat through the carpet as shown in the results above. The slip layer is also a very good medium to help protect the outer foil layer surrounding the heating mat from wear.

Wherein the foregoing description reference has been made to integers or components having known equivalents, then such equivalents are herein incorporated as if individually set forth.

Although the invention has been described by way of example and with reference to possible embodiments it is to be appreciated that improvements and/or modifications may be made to these embodiments without departing from the scope of the invention.

1. A method of installing a flexible floor cover heating system over a floor surface, comprising:
(a) locating a heating mat over a floor surface and under a flexible floor cover layer; and
(b) locating a slip layer between the heating mat and the flexible floor cover.

2. The method of claim 1 which further comprises locating an underlay layer under the heating mat.

3. The method of either claim 1 or claim 2 wherein the flexible floor cover layer is a carpet layer or a rug layer that does not comprise an insulative backing layer.

4. The method of claim 1 wherein the slip layer and the heating mat are of substantially equivalent dimensions.

5. The method of claim 4 wherein the slip layer comprises a synthetic material.

6. The method of claim 5 wherein the synthetic material is polypropylene or nylon.

7. The method of claim 6 wherein the synthetic material is polypropylene 100 gsm spun bound.

8. The method of claim 1 wherein of the slip layer has a thickness that is between 0.1 mm and 2.0 mm.

9. The method of claim 8 wherein the thickness of the slip layer is between 0.4 mm and 0.8 mm.

10. A floor cover heating system, comprising:
(a) a flexible floor cover layer;
(b) an under floor cover heating mat; and
(c) a slip layer positioned between the under floor cover heating mat and the flexible floor cover layer.

11. The floor cover heating system of claim 10 wherein the flexible floor cover layer is a carpet layer or a rug layer that does not comprise an insulative backing layer.

12. The floor cover heating system of claim 11 which comprises an underlay layer located underneath the under floor cover heating mat.

13. The floor cover heating system of claim 10 wherein the slip layer and the under floor cover heating unit are of substantially equivalent dimensions.

14. The floor cover heating system of claim 13 wherein the slip layer comprises a synthetic material.

15. The floor cover heating system of claim 14 wherein the synthetic material is polypropylene or nylon.

16. The floor cover heating system as of claim 15 wherein the synthetic material is polypropylene 100 gsm spun bound.

17. The floor cover heating system of claim 10 wherein the of the slip layer has a thickness that is between 0.1 mm and 2.0 mm.

18. The floor cover heating system as of claim 17 wherein the thickness of the slip layer is between 0.4 mm and 0.8 mm.

19. A method of reducing abrasion between a flexible floor cover layer and a heating mat positioned over a floor surface, comprising;
(a) locating a heating mat over a floor surface and under a flexible floor cover layer; and
(b) locating a slip layer between the heating mat and the flexible floor cover.

20. The method of claim 19 which further comprises locating an underlay layer under the heating mat.

21. The method of either claim 19 or claim 20 wherein the flexible floor cover layer is a carpet layer or a rug layer that does not comprise an insulative backing layer.

22. The method of claim 19 wherein of the slip layer and the heating mat are of substantially equivalent dimensions.

23. The method of claim 22 wherein the slip layer comprises a synthetic material.

24. The method of claim 23 wherein the synthetic material is polypropylene or nylon.

25. The method of claim 24 wherein the synthetic material is polypropylene 100 gsm spun bound.

26. The method of claim 19 wherein the slip layer has a thickness that is between 0.1 mm and 2.0 mm.

27. The method of claim 26 wherein the thickness of the slip layer is between 0.4 mm and 0.8 mm.
